(19) United States
(12) Patent Application Publication
(10) Pub. No.: US 2006/0236061 A1
(43) Pub. Date: Oct. 19, 2006

(54) Systems and methods for adaptively deriving storage policy and configuration rules

(75) Inventor: Michael Koclanes, Boulder, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: CREEK PATH SYSTEMS, Longmont, CO (US)

(21) Appl. No.: 11/108,181

(22) Filed: Apr. 18, 2005

(51) Int. Cl. G06F 12/00

(52) U.S. Cl. 711/170

(57) ABSTRACT

In one embodiment, the invention relates to an adaptive engine for creating provisioning policies and rules for network storage provisioning, which can be driven by service level objectives. The service level objectives can be defined for a given quality of service (“QoS”) for one or more users or user groups, file systems, databases, or applications, or classes of file systems, databases, or applications. In addition, the service level objectives can define the cost, availability, time to provision, recoverability, performance and accessibility objectives for the file system, database or application.

### CROSS-REFERENCE TO RELATED APPLICATIONS

This application claims the benefit of U.S. Provisional Application No. 60/563,749, filed Apr. 19, 2004. U.S. Provisional Application No. 60/563,749 is entitled “Systems and Methods for Adaptively Deriving Storage Policy and Configuration Rules,” and is incorporated herein by reference for all purposes.

### BACKGROUND OF THE INVENTION

The present invention relates generally to storage area networks, and more particularly to systems and method for adaptively deriving storage policy and configuration rules based on service level objectives and storage network characterizations.

Storage Management solutions that exist in the market today require the definition of storage rules and policies that are explicitly defined by the user of the storage management application. The storage administrator or storage architect must decide on storage provisioning rules and policies to match the tiers of storage service levels desired as an outcome of that provisioning. This is currently done by defining the rules for RAID levels, volume management, replication, and/or back-up and recovery to hit an intended Quality of Service (“QoS”).

One inherent problem in this approach is that the storage administrator must possess the internal knowledge about all the possible storage elements that could be utilized within a complex storage networking environment to meet a given QoS. Furthermore, explicit rules do not adapt to changes in the storage network environment, and because the prior art approach is manual and mostly static, it cannot adapt to dynamic changes in the environment, such as utilization patterns and performance bottlenecks. Finally, with the prior art approach, changes in service level objectives must be manually considered for their impact on provisioning policy and rules.

By way of example, a requirement for high availability may require that a volume for a file system be mirrored. The explicit rule for this class of storage may be to use a RAID 1+0 set in a given class of storage array and to replicate it to a similar array, in an array-to-array synchronous fashion. This static rule may meet the requirement for the time being. Other choices may be appropriate, however, in light of other QoS objectives, such as cost or utilization. Further, changes might happen in the environment that are often driven by business objectives. For example, the acceptable cost for the storage might be limited to meet cost cutting objectives. Thus, changes in service level objectives, changes in storage managed element configurations, and periodic audits of current state may trigger an analysis and perhaps a change of the provisioning rules and policies. Thus, what is needed is a system and method for analyzing and changing provisioning rules automatically, without the need for using the previously known manual processes.

### BRIEF SUMMARY OF THE INVENTION

In one embodiment, the invention relates to an adaptive engine for creating provisioning policies and rules for network storage provisioning, which can be driven by service level objectives. The service level objectives can be defined for a given quality of service (“QoS”) for one or more users or user groups, file systems, databases, or applications, or classes of file systems, databases, or applications. In addition, the service level objectives can define the cost, availability, time to provision, recoverability, performance and accessibility objectives for the file system, database or application.

In one embodiment, the adaptive engine of the present invention can consider the characterization of all managed storage elements, in its domain, such as, arrays, switches and directors, volume managers, data managers, and host bus adapters, its internal knowledge base of network storage provisioning practices, and the current state (utilization of capacity and bandwidth) of the storage network managed elements to derive an appropriate set of policy and rules to drive a provisioning process. In one embodiment, the adaptive engine comprises a modeling and heuristics planning engine to derive the appropriate policies and rules.

In one embodiment, the adaptive engine is configured to analyze and derive policy and rules when: (1) service level objectives are set or changed; (2) there are new or changed managed storage elements in the network that are believed to have an impact on service levels; (3) periodic audits are performed that look at actual service levels versus service level objectives, significant deviations from objectives will trigger re-planning; or (4) periodic model based planning runs are performed which will iterate through trial configurations finding the best fit solution sets for defined service level objectives. The dynamic and adaptive nature of the adaptive engine of the present invention is revolutionary in its ability to optimize the use of storage network assets and to manage the complexity of large storage network environments with minimal human intervention. Conventional technologies require explicit rule definitions, and do not adapt automatically to environmental or business service level dynamics.

In one embodiment, the adaptive engine allows for additions of new elements into the base model that have characterized as forecasted additions to the discovered infrastructure. The extended model can be used to verify the potential to improve or offer new service levels. This is a planning mode use of the invention versus the derivation of policy and rules to drive the actual provisioning engine.

Further, in accordance with one embodiment of the present invention, the policies and rules derived by the adaptive engine can serve as constraints in the execution of an automated provisioning engine. Embodiments of such an automated provisioning engine are described in U.S. patent application Ser. No. 10/447,677, filed on May 29, 2003, and entitled “Policy Based Management of Storage Resources,” the entirety of which is incorporated by reference herein for all purposes.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a schematic diagram illustrating an exemplary operating environment for carrying out adaptive derivation of storage policy and configuration rules;

FIG. 2 is a block diagram illustrating an overview of one embodiment of an adaptive engine of the present invention;

FIG. 3 is a block diagram illustrating an exemplary process of using an adaptive engine and automated provisioning engine;

FIG. 4 is a diagram illustrating one embodiment of a graphical user interface that can be used to modify service level categories for storage provisioning;

FIG. 5 illustrates an embodiment of a graphical user interface that can be used to enter model storage elements that may be used for generating a capabilities matrix and/or for use in the planning mode;

FIG. 6 illustrates an embodiment of a graphical user interface that can be used to enter model storage element attributes that may be used to generate a capabilities matrix and/or for use in the planning mode;

FIG. 7 is a block diagram illustrating one example of managed storage element classes and inheritances;

FIG. 8 is a chart illustrating the relationship between cost of downtime, cost to rebuild data and system cost for one example of a data processing system;

FIG. 9 is a flow chart showing one embodiment of a method for deriving a policy and rule solution set in accordance with the present invention; and

FIG. 10 is a block diagram illustrating a general-purpose computer that can be used to implement a policy based storage management engine.

### DETAILED DESCRIPTION OF THE INVENTION

The present invention relates generally to storage area networks, and more particularly to systems and method that can adapt to changes in service level objectives, changes to storage network configurations, the current state of the storage network and its ability to meet service level objectives to derive a set of provisioning policies, and rules to meet those service level objectives.

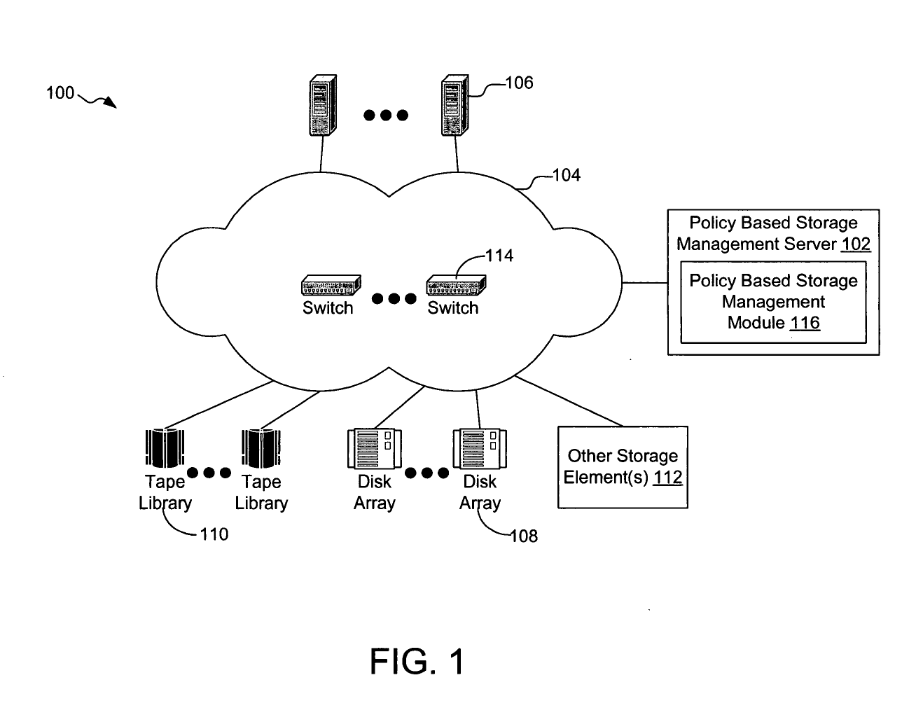

FIG. 1 is a schematic diagram illustrating an exemplary operating environment 100 in which adaptive storage policy and rules derivation can be carried out. The operating environment 100 includes a policy based storage management (PBSM) server 102 that generally performs functions related to adaptively deriving policy and rules, based on certain events, settings, or data. PBSM server 102 can be implemented as one or more server computers in this embodiment.

A storage area network (SAN) 104 (or SAN fabric) connects storage elements and makes them accessible to application servers 106 and the PBSM server 102. The SAN 104 may be centralized or decentralized. Types of storage elements that are typically provided include disk arrays 108, tape libraries 110, or other storage elements 112. Other storage elements 112 may include logical software elements like volume managers, replication software, and multi-path I/O software. The disk arrays 108, tape libraries 110, and other storage elements 112 are collectively referred to as managed storage elements. As is discussed in further detail below, the PBSM server 102 can use information related to the managed storage elements, as well as other information, such as modeling data and user input, to adaptively derive policy and rules for provisioning storage elements on the SAN 104.

The SAN 104 typically includes a number of SAN switches 114. In accordance with a particular embodiment, the SAN 104 provides connections via Fibre Channel (FC) switches 108. Other types of switches may be used. Although not shown, host bus adapters (HBAs) are also typically provided. The SAN fabric 104 is generally a high-speed network that interconnects different kinds of data storage devices with associated servers. This access may be on behalf of a larger network of users. For example, the SAN 104 may be part of an overall network for an enterprise. The SAN 104 may reside in relatively close proximity to other computing resources but may also extend to remote locations, such as through wide area network (WAN) carrier technologies such as asynchronous transfer mode (ATM) or Synchronous Optical Networks, or any desired technology, depending upon requirements.

Application servers 106 execute application programs (also referred to as applications) that store data on and retrieve data from the storage elements via the SAN 104. The SAN 104 typically can offer varying degrees of data security, recoverability, availability, etc. To meet these goals, the SAN 104 and the managed storage elements variously support disk mirroring, backup and restore, archival and retrieval of archived data, data migration from one storage element to another, and the sharing of data among different servers in a network 104. SANs 104 may also incorporate sub-networks with network-attached storage (NAS) systems.

The PBSM server 102 may be incorporated into the SAN 104. The PBSM server 102 is configured to communicate with the application servers 106 and the managed storage elements through the SAN fabric 104. Alternatively, the PBSM server 102 could perform these communications through a separate control and/or data network over IP (or both the separate network and the SAN fabric 104).

According to one embodiment, the SAN environment 100 attempts to provide storage in accordance with one or more service level objectives (SLOs). In a preferred embodiment, SLOs are associated with applications running on the application servers 106. Optionally, these SLOs may correspond to a service level agreement (SLA). The service level objectives (SLOs) for applications can vary from one application to another. Typically, every enterprise operates on its core operational competency. For example, customer relationship management (CRM) applications may be most critical to a service provider, while production control applications may be most critical to a manufacturing company. As another example, in the financial services industry, were government laws can result in service level requirements for data protection, archive policies and recovery/accessibility objectives. As such, the company's business can dictate the relative importance of its data and applications, resulting in business policies that should apply to all operations, especially the infrastructure surrounding the information it generates, stores, consumes, and shares. In that regard, SLOs for metrics such as availability, latency, and security for shared storage are typically promulgated to be in compliance with business policy.

The various storage elements (e.g., disk arrays 108, tape library 110, and other storage elements 112) each can have different capabilities or provide different services or meet different performance levels. As such, for a given cost, a particular configuration of the various storage elements may be best suited to meet a particular SLO or set of SLOs. More than one configuration could meet a SLO. Storage element provisioning policy and rules can be adapted and derived by the PBSM server 102 to accommodate various SLOs given the available managed storage elements.

In one embodiment, the PBSM server 102 executes a PBSM module 116 for carrying out policy based storage management. In this respect, the PBSM module 116 generally heuristically determines storage provisioning policy and rules based on information related to the managed storage elements. The PBSM module 116 can also determine and/or propose policy and rules based on modeled storage elements. Modeling is therefore useful in planning for provisioning of additional or alternate storage elements and/or configurations.

Policy and rules can be adaptively derived based on various criteria, including, but not limited to service level objectives (SLOs), managed storage elements in the network, results of audits that analyze actual service levels compared to service level objectives, or results of model based planning. As such, the PBSM module 116 typically receives and/or includes various data, such as SLOs for various applications using storage through the SAN environment 100. In some embodiments, the PBSM module 116 further implements metrics to ensure that policies and SLOs are being adhered to, and provides workflow definitions for provisioning storage resources in accordance with the policies.

FIG. 1 is illustrative of only one possible storage network configuration. It should be understood that distributed storage elements do not necessarily have to be attached to a FC SAN, and the present invention is not so limited. For example, PBSM functions carried out by the PBSM module 116 may also apply to storage systems directly attached to a local area network (LAN), those that use connections other than FC such as IBM Enterprise Systems Connection, or any other connected storage. These various systems are generally referred to as storage networks.

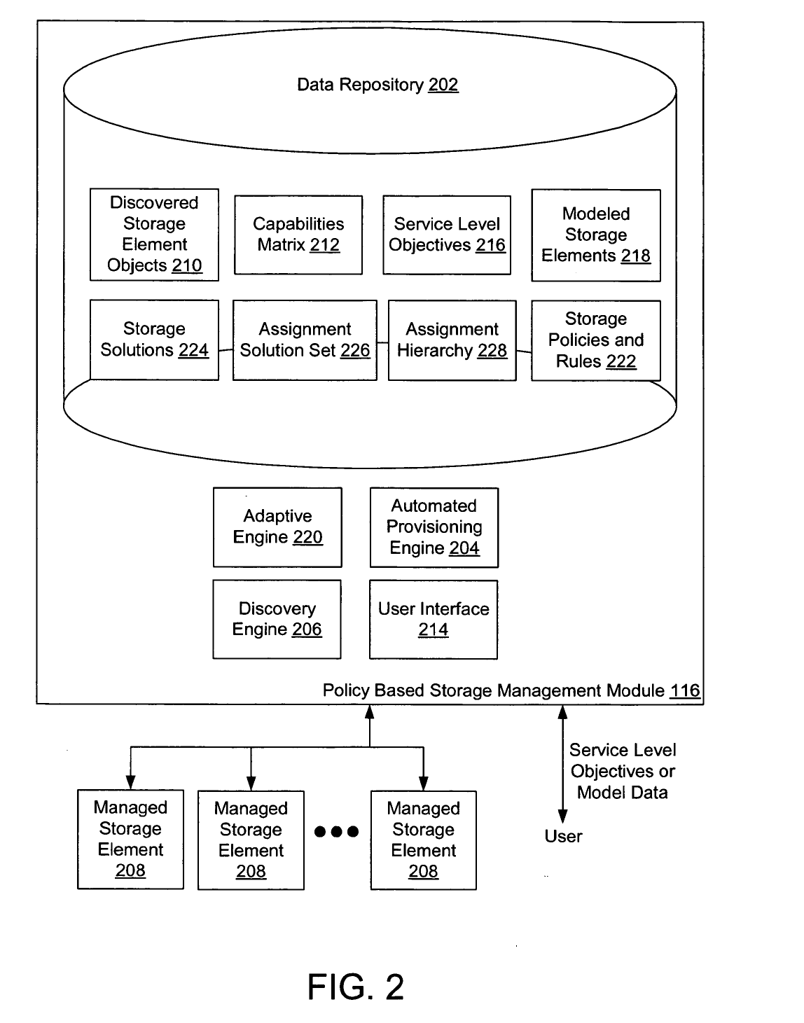

FIG. 2 is a functional block diagram illustrating modules and data in accordance with one embodiment of a policy based storage management (PBSM) module 116. The modules and data in the PBSM module 116 generally facilitate adaptive derivation of storage policy and rules based on information related to storage elements or other data. Data is generally stored in and retrieved from a data repository 202.

The derived storage policy and rules can be used to provision storage accordingly. As such, this particular embodiment of the PBSM module 116 includes an automated provisioning engine 204. The automated provisioning engine 204 uses policies and rules from the adaptive engine 218 (discussed below) as constraints in the storage provisioning process. In other embodiments, the PBSM module 116 may not include the provisioning engine 204, but rather, the provisioning engine 204 could be a separate module in communication with the PBSM module 116. A detailed description of embodiments of the automated provisioning engine 204 is provided in U.S. patent application Ser. No. 10/447,677, entitled “Policy Based Management of Storage Resources”. In still other embodiments the storage provisioning process is manual, and the automated provisioning engine 204 is not required.

In accordance with one embodiment, the PBSM module 116 can receive various types of information from various sources. In one embodiment, the PBSM module 116 includes a discovery engine 206 that discovers or identifies managed storage elements 208 that are available for use and/or configuration. In some embodiments, the discovery engine 206 identifies both local and remote storage elements. In some embodiments, the discovery may have been completed by an associated automated provisioning engine 204.

The discovery engine 206 executes a process of discovering or identifying the managed storage elements 208 (e.g., tape libraries 110, disk arrays 108, other storage elements 112) and their configurations. This process involves gathering and/or providing storage element identification information related to the storage elements 208. In one embodiment, the storage element identification information is stored in discovered storage element objects 210 that represent the managed storage elements 208. For example, an object can be instantiated for each managed storage element 208 that is discovered. Discovered storage element objects 210 maintain identifier data, such as storage element type or model, and the like. One embodiment of the discovery engine 206 discovers storage element data by signaling the storage elements 208, which reply with identification information. In other embodiments, the discovery engine 206 retrieves the data from a knowledge base (e.g., database) of storage element information. The discovery process may be triggered by addition or configuration of new storage elements 208.

The discovery engine 206 can also gather capabilities information related to discovered storage elements. Capabilities information may also be received from other sources, such as user input, online manuals, or databases. Capabilities information characterizes a storage element 208 by providing attributes relevant to considering whether, or to what extent, the storage element 208 is able to meet specified SLOs. As such, capabilities information can be used to analyze the managed storage elements 208 with regard to meeting specified SLOs. Exemplary capabilities include capacity, RAID level support, costs, interfaces (e.g., FC, IP, SSCI, etc.), I/O bandwidth, cache, I/O performance, and array-to-array replication. In one embodiment, the discovery engine 206 populates a capabilities matrix 212 with capabilities and associates managed storage element objects 210 with corresponding capabilities.

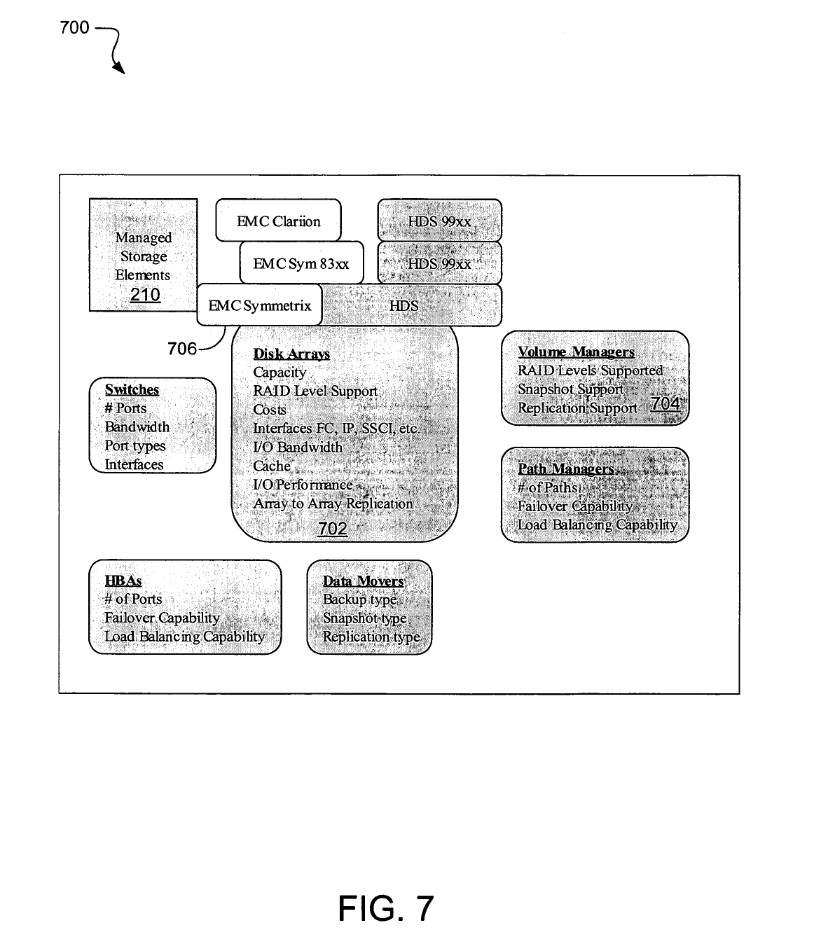

An embodiment of a class diagram 700 for use in creating storage element objects 210 is illustrated in FIG. 7. In order to facilitate a broad range of suppliers of managed storage elements, the managed elements are defined in classes 702, 704 and there is a notion of class inheritance. The classes provide characterization of managed storage elements, and their ability to meet service level objectives in each applicable attribute of quality of service. In this respect, FIG. 7 also depicts an example of the attributes of each storage element, and characterization and attributes that are considered in the element's ability to meet service level objectives. For example, as illustrated in FIG. 7, an EMC Symmetrix array 706 has the same attributes as other disk arrays 702, but the values of those attributes may vary. The storage element characterization can be defined at the family level of the array, such as Symmetrix or Clariion, or at the specific model number or even the specific frame, as shown. Some of the characteristics can be supplied through the discovery process, while others can be provided in the knowledge base and can be modified by the user of the PBSM module 116.

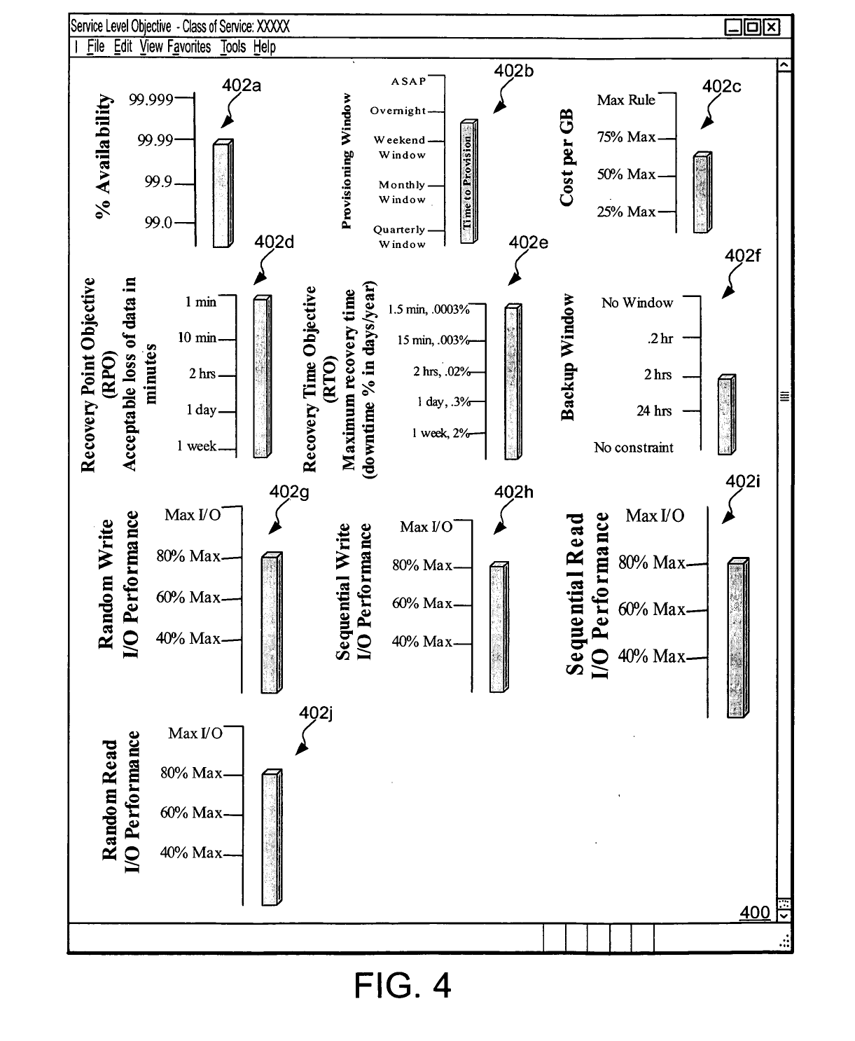

Referring again to FIG. 2, the PBSM module 116 can receive user input through a user interface (UI) 214. User input information may include, but is not limited to, service level objective (SLO) settings 216, and model storage element information 218. With regard to model storage element information 218, the PBSM module 116 employs planning functions that can run modeling scenarios to derive policy and rules based on new storage elements that could be added to the set of managed storage elements. An exemplary UI for setting SLOs is shown in FIG. 4.

With reference to FIG. 4, an embodiment of a graphical user interface (GUI) 400 is shown that can be provided by the policy based storage management module 116. Generally, the GUI 400 enables a user to set one or more service level objectives (SLOs) for tiered classes of storage. In this embodiment of the GUI 400, graphical service level control bars 402a-j can be used to adjust the SLOs. Exemplary SLOs include availability 402a, random write I/O performance 402g, sequential write I/O performance 402h, sequential read I/O performance 402i, random read I/P performance 402j, back-up window 402f, provisioning window 402b, cost per GB 402c, Recovery Point Objective(RPO), an acceptable loss of data 402d, RTO maximum recovery time 402e, and maximum acceptance cost. Other SLOs can be included in a GUI as may suit a particular implementation. In accordance with the illustrated embodiment, the GUI 400 enables a user (e.g., the storage architect) to slide the control bar 402a-j for the corresponding service level categories to a selected value or setting. Note that these categories can have dependencies, usually between costs and higher levels of service.

As one skilled in the art will appreciate, highest performance, recoverability, and availability typically cannot have the lowest costs. Thus, the slide bars or control bars 402a-j can be controlled programmatically to adjust appropriately for these tradeoffs to be considered in defining the tiered storage classes. For example, if the user attempts to select an availability 402a of 99.999 at a cost 402c of only 25% max, the GUI can automatically display an increase to the cost 402c, to correspond to the cost required to meet the selected availability 402a. This is a function of interdependence of service level objectives, minimizing costs while attaining a minimally acceptable level of the other service level objectives. It is also constrained by the capabilities of the discovered environment and the knowledge base characteristics of the known components.

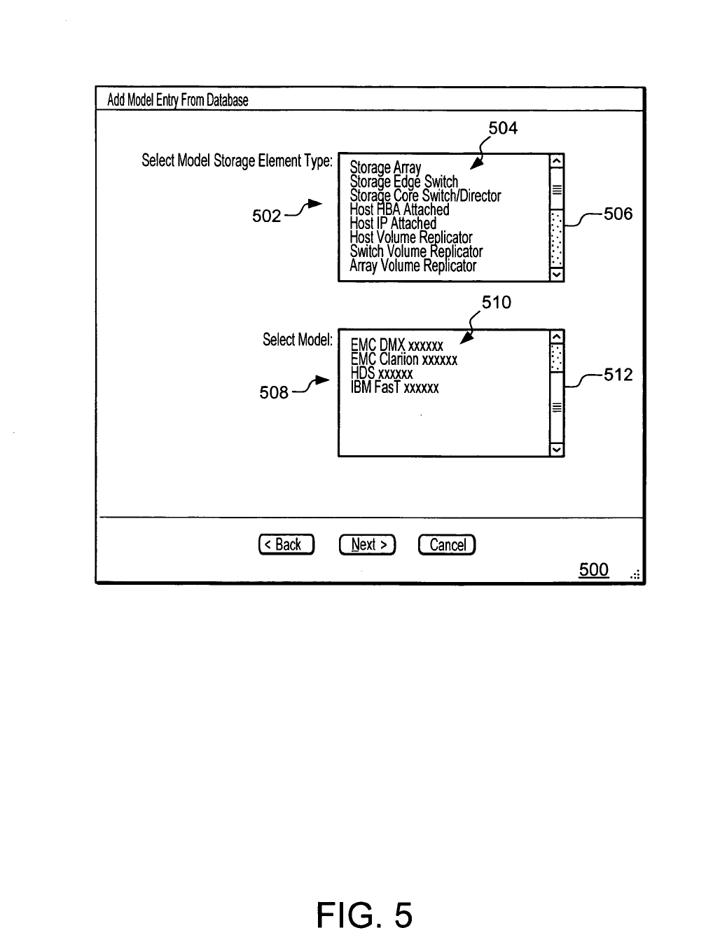

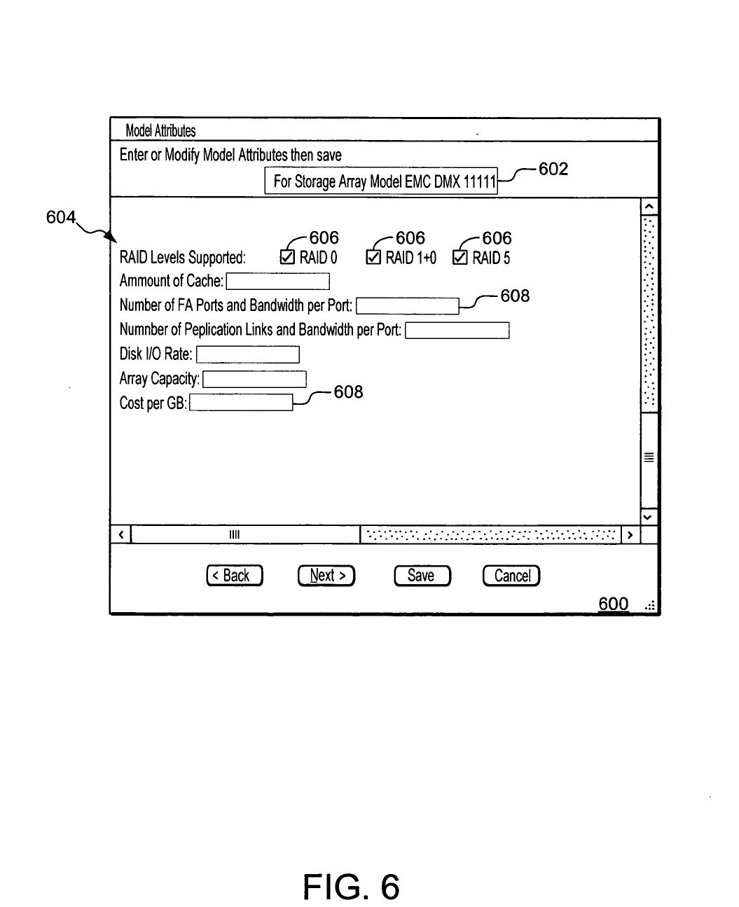

As discussed herein, undiscovered items in the knowledge base could be added for analysis in a planning mode. In other words, if a capability would be added by including a new type of managed storage element into to the storage environment, the new capability can be modeled to determine what storage configurations could be enabled in terms of the classes of service at given costs. FIGS. 5 and 6 illustrate exemplary user interfaces for use in the planning mode.

FIG. 5 illustrates an embodiment of a graphical user interface 500 that can be used to enter model storage elements that may be used in the planning mode and/or for generating a capabilities matrix. The exemplary GUI 500 includes a type selection utility 502 with which the user can select a type of storage element to be modeled. In this particular embodiment, the type selection utility 502 includes a list 504 of possible storage element types that the user can select with a pointing device, such as a mouse. The user may view other possible types by moving scroll bar 506. Data repository 202 (FIG. 2) is populated with storage types that will be made available for modeling.

GUI 500 includes a model selection utility 508, with which the user can select the model of storage device to be modeled. In this embodiment, the model selection utility 508 includes a list 510 of available models, with a scroll bar 512 for viewing models in the list. Although embodiments shown here use windows-based data selection/entry, it is to be understood that the model data may be entered in other ways. For example, the user interfaces are not limited to graphical user interfaces. As another example, the model types and models may be entered by typing text into a text entry field.

FIG. 6 illustrates an embodiment of a graphical user interface 600 that can be used to enter model storage element attributes to generate a capabilities matrix and/or to model storage elements in the planning mode. In this particular embodiment, the GUI 600 is based on the model and type of storage device selected in the GUI 500. Thus, for example, a model/type field 602 identifies the model and type for which attributes are being selected in the GUI 600. A list 604 of modifiable attributes is displayed to the user. For example, RAID levels supported can be selected with check boxes 606. As illustrated, in this particular embodiment, the user can choose RAID 0, RAID 1+0, and/or RAID 5. Text entry fields 608 enable the user to enter data corresponding to the other attributes in the list 604.

Returning to FIG. 2, an adaptive engine 220 uses the acquired storage element data and settings to adapt and/or derive storage policy and rules 222. In accordance with one embodiment, the adaptive engine 220 derives policy and rules 222 for provisioning storage based on one or more of the discovered storage elements 210, the capabilities matrix 212, the SLOs 216, and the modeled storage elements 218. The adaptive engine 220 also uses and/or generates storage solutions 224, an assignment solution set 226, and an assignment hierarchy 228 in the process of deriving the storage policy and rules 222. Generally, storage solutions 224 specify policies to meet associated objectives. Assignment solution set 226 generally associates objectives with storage elements and/or configurations of storage elements. An assignment hierarchy 228 is the sequence in which the storage elements and/or configurations should be applied.

With more specific regard to storage solutions 224, storage solutions 224 can include criteria relevant to determining policies for provisioning storage elements. In one embodiment, the storage solutions 224 include rankings, rules, formulas and/or algorithms for determining best policy and rules for provisioning to optimize for each service level objective, and a weighting system for resolving conflicts in provisioning policy to balance service level objectives. For each service level objective there is a set of solutions that can meet that objective. Tables 1 and 2 below illustrate examples of solution sets 224 for recovery point objectives and maximum recovery time, respectively.

TABLE 1
Exemplary Solution Set for Recovery Point Objective

| Recovery Point | | |
|---|---|---|
| Objective | | |
| (RPO) | | Solution Set |
| 10,000 | Min. | No Mirroring Archive to Tape Weekly. RAID Level 0 |
| | (1 | or 5 defined by cost and performance objective. |
| | Week) | |
| 1440 | Min. | No Mirroring Daily Incremental Weekly Full Backup. |
| | (1 day) | RAID Level 0 or 5 defined by cost and performance |
| | | objective. |
| 120 | Min. | Mirror and Snapshot every two hours; Backup/Restore |
| | (2 hrs.) | from Snapshot. RAID Level 1 + 0. |
| 10 | Min. | Mirror. Asynchronous or Synchronous replication to |
| | (0.17 | local/remote Business Continuity Volume; transaction |
| | hrs.) | journaling. Restore is failover to mirror. Dual path |
| | | active/inactive. Frequent snapshots and dump of |
| | | transaction journals. RAID Level 1 + 0. |
| 1 | Min. | Mirror and synchronous replication to second local |
| | (0.017 | mirror. Asynchronous replication to remote Business |
| | hrs.) | Continuity Volume; transaction journaling. Restore is |
| | | failover to mirror. Dual path active/active. Frequency |
| | | snapshots and dump of transaction journals. RAID |
| | | Level 1 + 0. |

TABLE 2
Exemplary Solution Set for Recovery Time Objective

| (RTO) Maximum | | |
|---|---|---|
| Recovery Time | | |
| (downtime | | |
| % in days/yr) | | Solution Set |
| 7 | days (2%) | Restore from off-line/off-site tape |
| 1 | day (0.3%) | Restore from local tape, near online in tape library |
| 2 | hours (0.02%) | Restore from snapshot |
| 15 | min. (0.003%) | Restore by failover to replicate volume, alternate |
| | | path enable |
| 1.5 | min. (0.0003%) | Restore is automatic with active/active paths |

Determining Cost Constraint

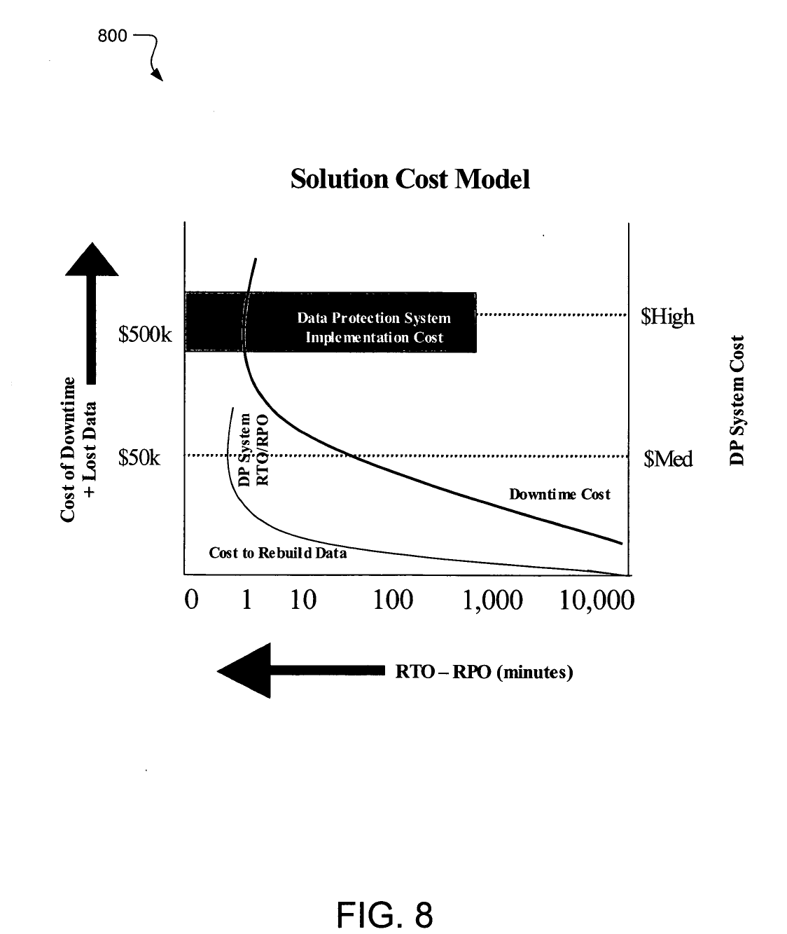

In one embodiment, cost is determined as a maximum acceptable percentage of the rate for the highest tier of storage. In accordance with this embodiment, an appropriate data protection cost can be determined by the cost model 800 shown in FIG. 8. In this particular embodiment, the cost model suggests the lowest cost solution that matches the RTO and RPO objectives. Each performance objective can also impact costs as it determines the RAID striping solution and class of storage elements used to meet that objective. The total cost is a function of the total amount of raw space allocated, impacted by striping, number of mirrors, replication costs, port bandwidth utilized, and class of storage array and class of storage network (FC is typically more costly per port than an IP NIC card for iSCSI or NAS). Most of these choices are based on the RTO and RPO service levels.

Thus, the following model can be used. First find all storage array pools or virtualization pools that can deliver a primary logical volume which meets the performance objectives and availability objectives. This can be accomplished by determining the class of array and RAID levels required for Volume Assignment. Next, determine the type of Path Assignment that will be required to meet performance and availability objectives. Additional significant cost contributions, however, are extra mirrors and replicated copies and snapshots to meet the RPO and RTO objectives, replication objectives and backup and recovery objectives drive further filtering of the solution candidates for the service level objectives.

Referring again to storage solutions 224, the following Table 3 illustrates an example of how backup window constraints might impact backup window rules and policies:

TABLE 3
Exemplary Backup Window Solution Set

| Backup Window | Solution Set |
|---|---|
| No Window | Backup from broken replicated mirror |
| .2 hours | Clear transaction buffers, cache, take snap |
| | and backup from snap volume |
| 2 hours | For files having a backup throughput of less |
| | than two hours, backup to tape using multi-drive |
| | streaming for throughput. Otherwise, use snap. |
| 24 hours | For files having a backup throughput of less |
| | than 24 hours, backup to tape using multi-drive |
| | streaming for throughput. Otherwise, use snap. |
| No Constraint | Backup to tape at frequency required |

The following Table 4 illustrates an example of how provisioning time constraints might impact provisioning rules and policies:

TABLE 4
Exemplary Provisioning Time Constraint Solution Set

| Provisioning Time | |
|---|---|
| Constraint | Solution Set |
| ASAP | Each managed element has an average configuration response time |
| | attribute. For example, EMC Symmetrix takes considerably longer |
| | than basic storage arrays to process a configuration request. |
| | Provisioning request for as soon as possible is a request at the time of |
| | provisioning that weights this factor highest of all objectives and |
| | triggers finding the best solution meeting as many of the other |
| | objectives as possible. |
| Overnight | Schedules the actual configuration for the appropriate maintenance |
| | window |
| Weekend Window | Schedules the actual configuration for the appropriate maintenance |
| | window |
| Monthly Window | Schedules the actual configuration for the appropriate maintenance |
| | window |
| Quarterly Window | Schedules the actual configuration for the appropriate maintenance |
| | window |

Determining the Assignment Solution Set

In one embodiment, the adaptive engine 220 uses a set of models for performance and qualitative comparisons of storage elements as candidates for the assignment policy for a class of service. There are tables maintained in a model for each storage element 218 and the capabilities matrix for those elements discovered in the ecosystem 210 and 212. The model is extracted or derived from vendor supplied specifications, maintained through a planning model GUI, or derived from performance observations and metrics gathered by a storage discovery engine 206. The tables can be implemented as data structures in memory.

TABLE 5
Exemplary Array Component Effectiveness

| Array Type and Model RAID | |
|---|---|
| Level | EMC DMX Mirr2 |
| Capacity | 9.9TB |
| # FA Port and Bandwidth | 32, 1.0 |
| performance | |
| Cache Performance | .5 |
| RAID random read performance | .9 |
| RAID random write performance | .5 |
| RAID sequential read performance | 1.0 |
| RAID sequential write performance | .6 |
| Cost per GB | $xxx.xx |
| Replication Type | 1 = sync |

Table 5 associates classes of array type with its modeling heuristics. To interpret this table, performance coefficients range from 0 to 1.0. A value of 1.0 represents best in class performance, and 0.5 is 50% of that performance level.

TABLE 6
Exemplary Fabric Component Model

| Fabric Component | Brocade 12000 |
|---|---|
| #Edge Ports, Bandwidth | 30, 1.0 |
| Performance | |
| #ISL Ports, Bandwidth | 2, .5 |
| Performance | |
| Cost per Port Connection | $xxx.xx |

Table 6 associates fabric models and port types to performance coefficients. For example, ISL performance can range from, “No sharing=1” to “heavily shared ISL=0.1”. These values can be determined using historical data. Port counters in the discovery engine 206 can be used to examine utilization of ports.

TABLE 7
Exemplary Host Component Model

| | Solaris Server |
|---|---|
| Host Component Type | Emulex HBA |
| HBA Port Type and Performance | 2 GBs, .8 |
| HBA Port Type and Performance | 1 GBs, .4 |

Table 7 associates Host OS and HBA models pairs to a port performance coefficient.

TABLE 8
Exemplary Replication Model

| Replication Component | Veritas DVR |
|---|---|
| Replication Class | Sync or Async |
| Replication Performance | .7 Sync, |
| | .2Async |

Table 8 associates replication software to performance and synchronization characteristics.

The assignment of a solution set to a class of service follows a set of mathematical formulas to derive the solution candidates for that service level. These become the set of policy rules that drive the provisioning solution for this class of service. The models utilize the characteristics in the modeling tables above.

In an exemplary embodiment, the following mathematical model is used to select the appropriate Array Model/RAID pool for a class of service.
I set of candidate RAID pools(indexed by i)
J set of candidate arrays type(indexed by j)
Cᵢⱼ cost of storage for class of service from array type j from RAID pool i for a unit demand
D demand of class of service for Random Read I/O relative performance
E demand of class of service for Random Write I/O relative performance
F demand of class of service for Availability
G demand of class of service for Sequential Read I/O relative performance
H demand of class of service for Sequential Write I/O relative performance
dᵢⱼ 1 if array j is compatible with requested class of service (OS drivers) or 0 if not compatible
Rij I/O service level delivered by Array type j and Raid pool i for random read performance, e.g. 70% based on read performance coefficient in Table 5.
Wij I/O service level delivered by Array type j and Raid pool i for random write performance, e.g. 70% based on write performance coefficient in similar write I/O performance as Table 5.
Yij Availability level delivered by Array type j and Raid pool i
Tij I/O service level delivered by Array type j and Raid pool i for sequential read performance, e.g. 70% based on sequential read performance coefficient in Table 5.
Vij I/O service level delivered by Array type j and Raid pool i for sequential write performance, e.g. 70% based on sequential write performance coefficient in similar sequential write I/O performance as Table 5.

In this exemplary embodiment, the decision variables are as follows:
Xij=fraction of array type j's storage and pool i to assign volumes to for this class of service
The overall mathematical model is given below:

$${min}_{i I} {CijdjXij}_{j J}$$

$$subject to$$

$$Xij = 1 and$$

$${Rij}_{i I} {dij}_{j J} D and$$

$${Wij}_{i I} {dij}_{j J} E and$$

$${Yij}_{i I} {dij}_{j J} F and$$

$${Tij}_{i I} {dij}_{j J} G and$$

$${Vij}_{i I} {dij}_{j J} H$$

In a particular embodiment, the following mathematical model is used to select the appropriate Switch or Director type and port type for a class of service. One of the class of service requirements is the number of FA ports to map from the volume, 1 or 2, dependent on the availability service level.
I set of candidate port types(indexed by i)
J set of candidate switch or director types (indexed by j)
Cᵢⱼ cost of switch port connection for class of service from switch j for port type I per connection
E demand of class of service for bandwidth (0.1-1.0) aggregate bandwidth per port type required (1 is best in class 0.1 is 1/10 of that bandwidth)
dᵢⱼ 1 if port type j is compatible with requested class of service (OS drivers) or 0 if not compatible
Rij Bandwidth delivered by port type j and switch i for random read performance, e.g. 70% based bandwidth coefficient in Table 6.

In this embodiment, the decision variables are as follows:
Zij=fraction switch type j's and port type i to assign to this class of service
The overall mathematical model is given below:

$${min}_{i I} {CijdjZij}_{j J} , \\ subject to$$

$$Zij = 1 and$$

$${Rij}_{i I} {dij}_{j J} E and$$

In one embodiment, the following mathematical model is used to select the appropriate Fibre Adapter Array and type for a class of service. Selecting the appropriate FA Array and type is done after the selection of Xij, the array type and RAID pool type. The resulting selection represents a subset of the arrays Xij. One of the class of service requirements is the number of FA ports to map from the volume, 1 or 2, dependent on the availability service level.
I set of candidate FA port types(indexed by i)
J set of candidate Array (indexed by j)
Cᵢⱼ cost of FA port connection for class of service from switch j for FA port type I per connection
E demand of class of service for bandwidth (0.1-1.0) aggregate bandwidth per FA port type required (1 is best in class 0.1 is 1/10 of that bandwidth)
dᵢⱼ 1 if port type j is compatible with requested class of service (OS drivers) or 0 if not compatible
Rij Bandwidth delivered by FA port type j and switch i from Table 5.

In this embodiment, the decision variables are as follows:
Yij=fraction array j's and FA port type i to assign to this class of service
The overall mathematical model is given below:

$${min}_{i I} {CijdjZij}_{j J}$$

subject to

Yij is a member of the set Xij from the array and RAID pool selection

$$Yij = 1 and$$

$${Rij}_{i I} {dij}_{j J} E and$$

In one embodiment, the following mathematical model is used to select the appropriate Host Bus Adapter (HBA) and port type for a class of service. Selection of the appropriate HBA is done after the selection of Xij, the array type and RAID pool type. The selection results in a subset of the host types for this class of service Hij. One of the class of service requirements is the number of HBA ports to map from the volume, 1 or 2, dependent on the availability service level.
I set of candidate HBA port types(indexed by i)
J set of candidate HBA types (indexed by j)
Cᵢⱼ cost of HBA port connection for class of service from HBA type j for HBA port type I per connection
E demand of class of service for bandwidth (0.1-1.0) aggregate bandwidth per HBA port type required (1 is best in class 0.1 is 1/10 of that bandwidth)
dᵢⱼ 1 if port type j is compatible with requested class of service (OS drivers) or 0 if not compatible
Rij Bandwidth delivered by HBA port type j and HBA type i from Table 7.

The decision variables are as follows:
Vij=fraction HBA type j's and HBA port type i to assign to this class of service
The overall mathematical model is given below:

$${min}_{i I} {CijdjVij}_{j J}$$

subject to

Vij is a member of the set of Hosts of the type for this class of service

$${V}_{ij = 1} and$$

$${Rij}_{i I} {dij}_{j J} E and$$

In one embodiment, the following mathematical model is used to select the appropriate replication methodology for this class of service. Selection of appropriate replication methodology is performed after the selection of Xij, the array type and RAID pool type. The resulting selection represents a subset of the host types for this class of service Hij and array type Xij. In Table 7 the Host type indicates the replication capabilities of the host type. In Table 5 is the indication of the replication capabilities of the array type. Note that a virtualization appliance is both a host type and an array type in this model.
I set of candidate replication types(indexed by i)
Cᵢ cost of replication for replication type i
E demand of class of service for replication (1=replication required 0=no replication required)
dᵢⱼ 1 if replication type i is compatible with requested class of service, 0 if not compatible, i.e. synchronous or asynchronous driven by RPO and RTO objectives

In this embodiment, the decision variables are as follows:
Pj=fraction of replication type i to assign to this class of service
The overall mathematical model is given below:

$${min}_{i I} CidiPi , \\ subject to$$

$$Pi = 1 and$$

$${Pi}_{i I} di E and$$

Upon evaluation through the foregoing set of models the minimal cost candidates can be derived for an assignment policy for this class of service.
Pi=Replication Choice to use
Vij=HBA type and port type to use
Yij=Fibre Adapter Port Type to use
Zij=Switch and Switch port to map to
Xij=Array type and RAID level to use

In one embodiment, after minimal cost candidate storage elements are derived and stored as the assignment solution set 206, assignment hierarchies 228 are derived. Assignment hierarchies are generally a set of rules that will drive the provisioning engine sequence in finding the storage elements.

Determining Assignment Hierarchy

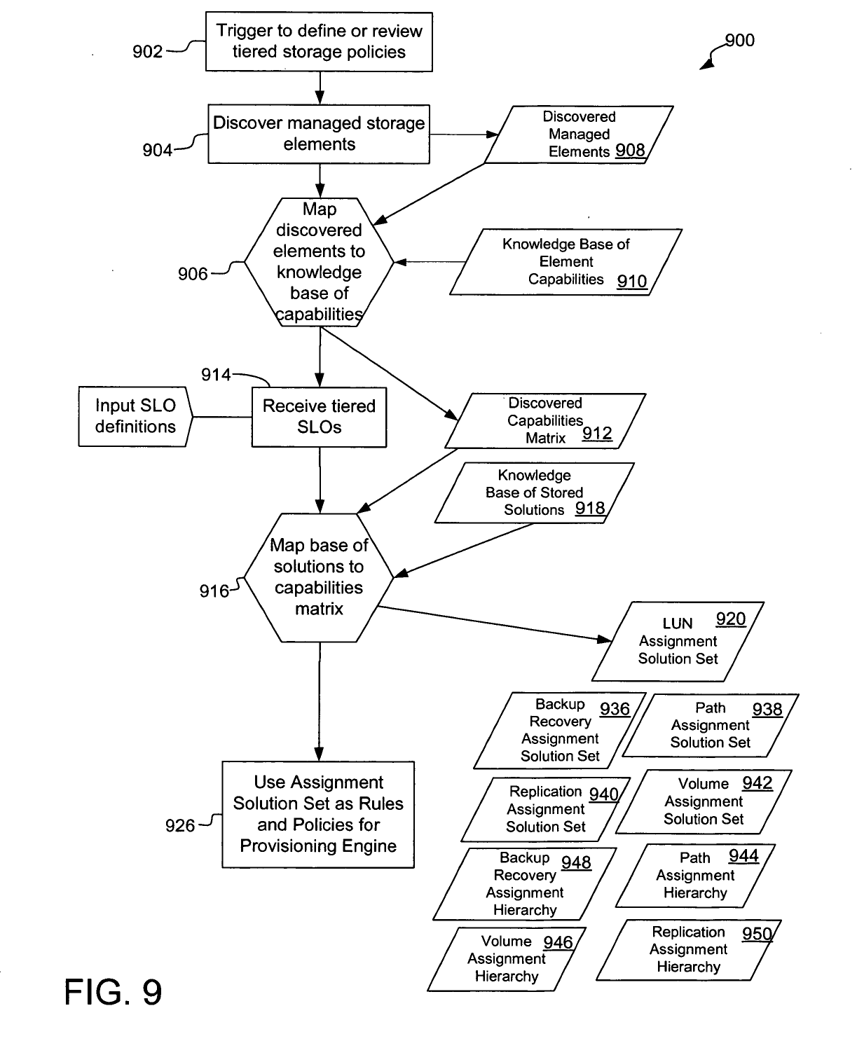

In one embodiment, the assignment hierarchy 228 includes multiple hierarchies related to factors associated with storage elements. For example, the assignment hierarchy 228 can include a volume assignment hierarchy, a path assignment hierarchy, a backup recovery assignment hierarchy, and a replication assignment hierarchy. It is to be understood that the invention is not limited to these exemplary hierarchies. The adaptive engine 220 employs functionality to determine the assignment hierarchy 228, and each hierarchy included therein. These exemplary hierarchies are now discussed with reference to FIG. 9.

Volume Assignment Hierarchy

As discussed, one of many factors to consider is the volume assignment hierarchy 930 (FIG. 9). In one embodiment, the following procedure can be used to determine a volume assignment hierarchy 930 in accordance with the present invention:

Consider the host level first for a volume or LUN of the class required, as defined in the volume assignment solution set 930 (For example: An array with cache optimization, synchronous array-to-array replication, RAID 1+0). If a host volume is available, all work can be done at the host file system and volume management level and the provisioning can stop at the host level.

```
If not, check for in-path virtualization appliances for the same class of
LUN. If available, map the LUN to the host from the virtualization
platform.
  If not, look for free volumes in the appropriate array of the required
  class. If available, map the LUN to the host, zoning as necessary.
    If not, see if a concatenated volume in the array can meet the
    requirement. If available, create concatenated volume and map LUN
    to the host, zoning as necessary.
      If not, look in RAID 1+0 pool and create volume, map to the
      fibre adapter port FA and host and zone as necessary.
        If not, look in the raw storage pool and add storage to
        RAID 1+0 pool, then create volume, map to FA and
        host, zone as necessary.
```

One embodiment of the invention includes a syntax for defining this search hierarchy to drive the provisioning engine through a workflow definition language.
Path Assignment Hierarchy

Another factor to consider is a path assignment hierarchy 928. For the defined LUN as described in the volume assignment hierarchy 930 above, the path assignment depends on factors, such as, dual pathing or single pathing, and active/active or active/inactive with failover, as derived from the RPO and RTO objectives and stored in the path assignment solution 938 set entries for path assignment. If dual paths are preferred or required, one solution might be to map the LUN to multiple FA ports on the array and from the FA ports to two different HBA ports on the server. Failover can be handled at the host level through configuration of products such as Veritas DMP or EMC Powerpath. Appropriate use or creation of current or new zones, including the proper storage elements and ports can be part of this process. In one embodiment, the adaptive engine is configured to pass workflow definition language for the appropriate sequence of operations and the policy/rules to act as constraints for the operations to an automated provisioning engine with the objective to meet the class of service requested. As discussed above, examples of an automated provisioning engine are described in U.S. patent application Ser. No. 10/447,677, which is incorporated by reference herein for all purposes.

Backup/Restore/Replication Hierarchy

Next comes the decisions for replication. Again, this typically is driven by the RPO and RTO objectives. The need for a local synchronous mirror, a replicated asynchronous mirror in another location, and snapshot frequency is driven by these two objectives. The backup assignment solution set 936 contains these derived policy rules. The rules are used by the provisioning engine to create the necessary volumes, set-up replication and paths, and set the schedule for backup and/or snap images. As such, the assignment solution set 936 comprises a set of steps forming a workflow definition. The workflow definition and the associated set of policy/rules are passed to the provisioning engine. The associated set of policy/rules can constrain each provisioning step, carried out in accordance with the workflow definition, to meet the service level and configuration requirements.

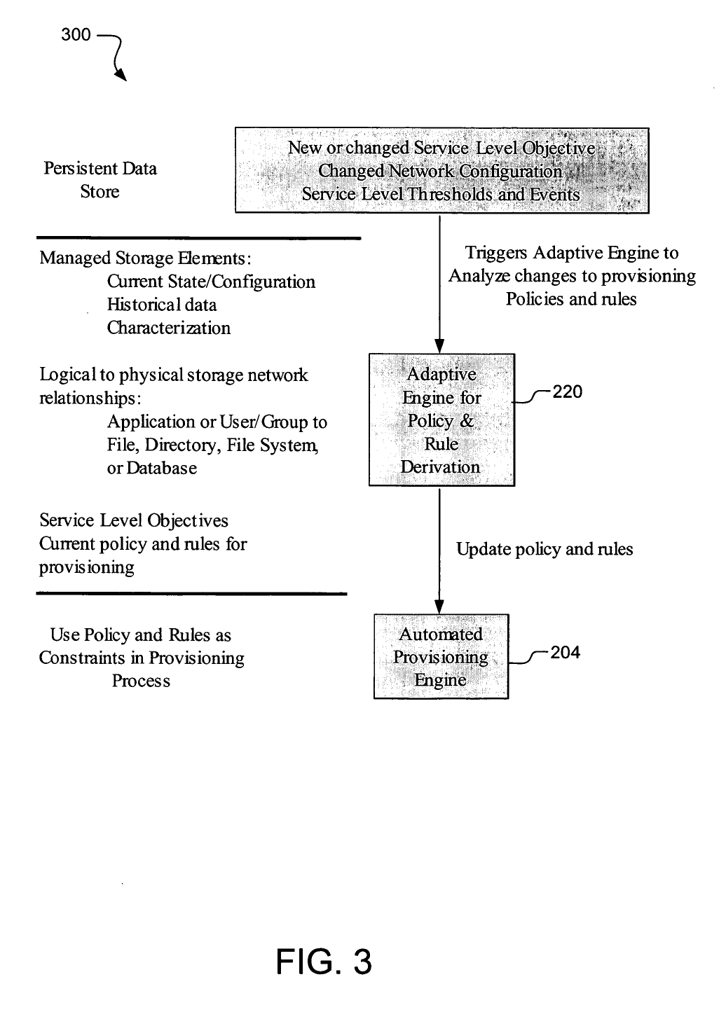

Turning now to FIG. 3, there is illustrated an exemplary data flow 300 for use in policy based storage management. Data in a persistent data store representing service level objectives, network storage configuration, and/or events can serve to trigger adaptation of policy rules. For example, when SLOs or the network storage configuration are changed, the adaptive engine 220 to generates or adapts storage provisioning policy rules as discussed herein. The policy rules generally facilitate identifying storage elements and their configurations, along with workflows to integrate the storage elements in the network in a manner that will meet the SLOs. As such, the policy rules are then used by the automated provisioning engine 204 (or a manual provisioning process) to provision the storage elements.

Note that in this description, in order to facilitate explanation, the PBSM module 116 is generally discussed as if it is a single, independent network device or part of single network device. However, it is contemplated that the PBSM module 116 may actually comprise multiple physical and/or logical devices connected in a distributed architecture; and the various functions performed may actually be distributed among multiple of such physical and/or logical devices. Additionally, in alternative embodiments, the functions performed by the PBSM module 116 may be consolidated and/or distributed differently than as described. For example, any function can be implemented on any number of machines or on a single machine. Also, any process may be divided across multiple machines. Specifically, the discovery engine 206 and the adaptive engine 220 may be combined as a single functional unit. Similarly, the adaptive engine 220 and the automated provisioning engine 204 may be combined as a single functional unit. Finally, data repository 202 may be a separate data repository in communication with the PBSM module 116; the data repository 202 may comprise multiple storage repositories that may be of differing or similar types. For example, data repository 202 may comprise a relational database and/or a repository of flat files.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer-readable media. Computer-readable media can be any available media that can be accessed by a computer. By way of example, and not limitation, computer-readable media may comprise “computer storage media” and “communications media.”

“Computer storage media” includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer-readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

Exemplary Operations

FIG. 9 is a flow chart illustrating an exemplary process or algorithm 900 for adaptively deriving storage provisioning rules and policy. The algorithm 900 can be carried out by the policy based storage management (PBSM) module 116 (FIG. 1, 2). Alternatively, the algorithm 900 can be carried out by another network-based system configured for analyzing, managing, and/or provisioning storage elements on the network.

Initially, the adaptive algorithm 900 is triggered by a triggering operation 902. In one embodiment, the triggering operation 902 monitors certain events, settings, and/or data. If a predetermined event, setting, or data is detected, the algorithm proceeds to evaluate or reevaluate the rules and policies. Exemplary trigger factors that may cause a reevaluation of the rules and policies for provisioning by tiered storage class include, but or not limited to, the following:
A change is made to the managed element configurations that may possibly enable a new performance coefficient, availability, backup or recovery capability, significantly impact cost or time to provision.
A manually triggered request to set new tier storage class provisioning rules.
New managed elements types, arrays, switches, hosts or fabric types are added or removed from the storage infrastructure.
Periodic audits of performance and availability statistics reveal that the performance and availability coefficient of tiered managed elements need adjusting.

After reevaluation is triggered, and before deriving the tiers of storage provisioning rules for the environment, a discovering operation 904 characterizes each managed element by the types of services, capacity, and bandwidth it is capable of delivering. In one embodiment, there is a knowledge base (e.g., data repository 202, FIG. 2) of the characteristics provided as part of the invention. A GUI can be provided to maintain this knowledge base, based on customer input and extensions to the supplied model. Furthermore, this knowledge base can be updated with actual heuristics discovered and gathered through the automated provisioning engine described in U.S. patent application Ser. No. 10/447,677, filed on May 29, 2003, and entitled “Policy Based Management of Storage Resources,” . This model is further filtered based on the subset of managed element types available in the customer's environment. This results in a capabilities matrix depicting the attributes by storage element, for example, as illustrated in FIG. 5 for that customer's environment.

After the discovering operation 904 discovers storage elements, a mapping operation 906 maps the discovered storage elements 908 to capabilities 910 in a knowledge base of element capabilities to generate a capabilities matrix. After discovering the elements and mapping elements to corresponding capabilities, the actual rules derivation/adaptation process occurs.

The flow chart 900 illustrates one embodiment of an adaptive process flow for a derived policy and rule solution set. As discussed above, in accordance with one example, the adaptive engine is used to define an acceptable service level for a class of storage by adjusting slider bars, for example, those shown in FIG. 4. A receiving operation 914 receives the SLO settings from the GUI input. In a mapping operation 916, the adaptive engine then compares this selection to the capabilities matrix 912, for example, the matrix illustrated in FIGS. 5-FIG. 7. At this point, the assumption is unconstrained by utilization of capacity or bandwidth.

Using the SLO settings, storage solutions 918, and the capabilities matrix 912, the mapping operation 916 derives a LUN assignment solution set 920 using the solution set derivation formulas previously described. These solution sets 936-942 will define which array classes, RAID level(s), replication classes, backup and recovery classes, multi-pathing technology, and volume aggregation technology can be used to meet the provisioning objectives for that select service level objectives. The next step involves defining the assignment hierarchies 944-950, for volume assignment, path assignment, backup recovery configuration and replication assignment. These hierarchies define the sequence of assignment and are constrained by the solution set previously derived. The result of the hierarchy is an assignment flow that will be expressed in a workflow definition language to control sequence of the provisioning process.

For example, a tiered storage service level for high performance, high availability, fast recovery, with cost as a minor consideration may have a derived assignment solution set as follows:

Exemplary Assignment Solution Set

LUN Attributes required: Mirr-2 in EMC DMX or SYM, or RAID 1+0 in HDS 9900
Path Attributes required: Use PowerPath, HDLM or DMP
Replication Attributes: Synchronous using SRDF or Veritas VVR
Backup Attributes required: Snapshot and recovery from mirror Timefinder and Netbackup
   The derived Assignment Hierarchy Solution set states:
LUN assignment Hierarchy: Step 1) Look for HDS Raid 1+0 first, EMC Mirr 2 second at the host volume manager level
   Step 2) Look for HDS Raid 1+0 first, EMC Mirr 2 second at the array level
      Step 2a) HDS LUSE or EMC META volumes first, then HDS LDEV or EMC Hypervolume level
Path Assignment Hierarchy Step 3) Map LUN to appropriate Fibre Adapter Port on array to match host OS type
   Step 4) PowerPath first if EMC and available on host server then DMP or
   Step 4) HDLM first if HDS and available on host server and then DMP
   Step 5) Perform zoning operations
Replication Assignment Hierarchy
   Step 6) If array type is EMC SYM or DMX set-up
   SRDF target(s) and BCVs, else set-up Veritas VVR

FIG. 9 also depicts backup recovery assignment solution set 936, path assignment solution set 938, replication assignment solution set 940, volume assignment solution set 942. FIG. 9. also depicts the associated backup recovery assignment hierarchy 948, path assignment hierarchy 944, replication assignment hierarchy 950 and volume assignment hierarchy 946.

Exemplary Computing Device

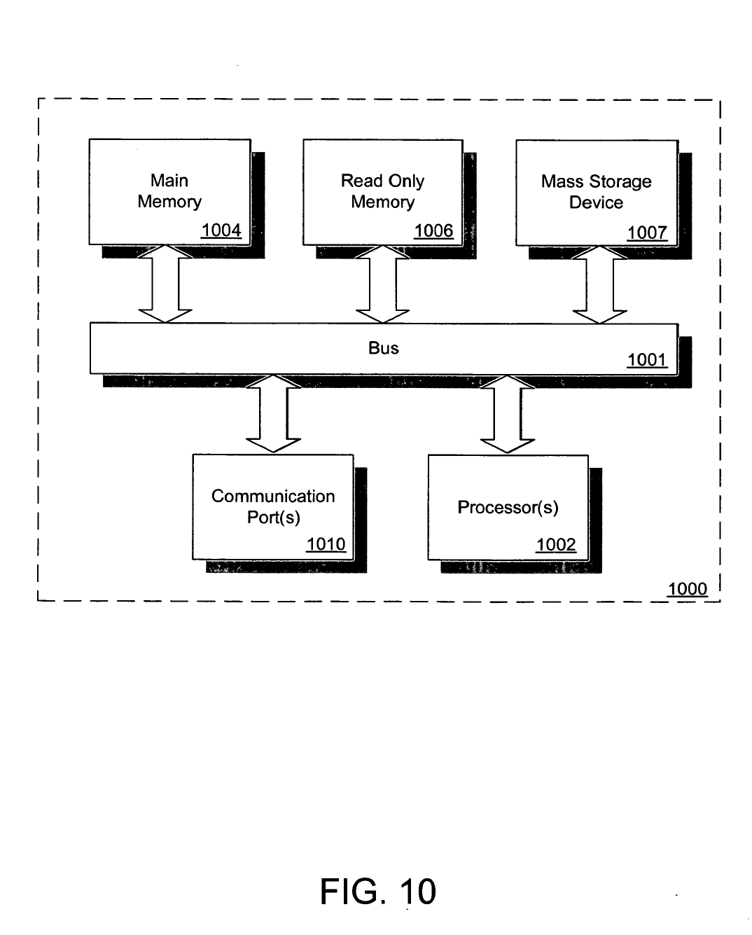

FIG. 10 illustrates an exemplary machine in the form of a computer system 1000. The computer system 1000 is representative of many types of computing devices and systems, such as an exemplary database server, application server, or policy based storage management (PBSM) server, or web server, in which features of the present invention may be implemented will now be described with reference to FIG. 10. In this simplified example, the computer system 1000 comprises a bus or other communication means 1001 for communicating information, and a processing means such as one or more processors 1002 coupled with bus 1001 for processing information.

Computer system 1000 further comprises a random access memory (RAM) or other dynamic storage device 1004 (referred to as main memory), coupled to bus 1001 for storing information and instructions to be executed by processor(s) 1002. Main memory 1004 also may be used for storing temporary variables or other intermediate information during execution of instructions by processor(s) 1002. Computer system 1000 also comprises a read only memory (ROM) and/or other static storage device 1006 coupled to bus 1001 for storing static information and instructions for processor 1002. A data storage device 1007 such as a magnetic disk or optical disc and its corresponding drive may also be coupled to bus 1001 for storing information and instructions.

One or more communication ports 1010 may also be coupled to bus 1001 for allowing communication and exchange of information to/from with the computer system 1000 by way of a Local Area Network (LAN), Wide Area Network (WAN), Metropolitan Area Network (MAN), the Internet, or the public switched telephone network (PSTN), for example. The communication ports 1010 may include various combinations of well-known interfaces, such as one or more modems to provide dial up capability, one or more 10/100 Ethernet ports, one or more Gigabit Ethernet ports (fiber and/or copper), or other well-known interfaces, such as Asynchronous Transfer Mode (ATM) ports and other interfaces commonly used in existing LAN, WAN, MAN network environments. In any event, in this manner, the computer system 1000 may be coupled to a number of other network devices, clients and/or servers via a conventional network infrastructure, such as a company's Intranet and/or the Internet, for example.

Embodiments of the present invention may be provided as a computer program product which may include a machine-readable medium having stored thereon instructions which may be used to program a computer (or other electronic devices) to perform a process according to the methodologies described herein. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### CONCLUSION

As described, the adaptive engine derives policy rules at certain trigger points and feeds the policy rules and workflow definition to a provisioning engine. It is not required that these trigger points (e.g., new managed element capabilities, infrastructure changes) are necessarily on a real-time basis. For example, a trigger point may be a planned infrastructure deployment projects that requires a new look at the policies and rules controlling provisioning. Preferably, the environment should not be too sensitive to changes. However, given sufficient processing power the service level objectives could be entered for each provisioning event and then the system could derive the optimal solution at that point in time. Some exemplary benefits include the ability to consider utilization and in real-time.

For example, the best way to meet the service level objectives might be to put dual paths through a McData fabric to an EMC array with array-to-array replication. The adaptive engine of the present invention is adapted to determine such a policy. However, the EMC array may be fully utilized or the McData Fabric saturated, so this policy, although correct, could result in an inability to provision. Thus, the adaptive engine can be configured to generate a next best policy scheme. For example, a Brocade fabric with two HDS arrays might accomplish almost as good of solution for the required service levels. Thus, the adaptive engine of the present invention can be configured to generate back-up policy schemes for cases when the best-case solution is not practical. More specifically, the adaptive engine can be configured to determine a rank set of solutions sets that meet the minimally acceptable service levels, and the provisioning engine can try the optimal one. If that fails due to capacity or bandwidth constraints, it can use the next best solution set.

In conclusion, the present invention provides novel systems and methods for adaptively deriving workflow definition and storage policy and configuration rules based on service level objectives and storage network characterizations. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for deriving a policy for provisioning storage resources, the method comprising:
discovering one or more storage elements that can be provisioned to meet one or more service level objectives;
mapping each of the discovered storage elements to associated capabilities;
mapping each of the capabilities to associated storage solutions;
mapping one or more storage solutions to each of the service level objectives; and
mapping each of the one or more storage solutions to a storage element capable of providing the storage solution.

2. A method as recited in claim 1 further comprising receiving the one or more service level objectives through a user interface.

3. A method as recited in claim 2 wherein the user interface includes a graphical user interface.

4. A method as recited in claim 3 wherein the graphical user interface comprises a slider control bar associated with each of the service level objectives, whereby a user can selectively set one or more of the service level objectives.

5. A method as recited in claim 4 wherein a first service level objective is dependent upon a second service level objective and setting the second service level objective causes automatic adjustment to the first service level objective.

6. A method as recited in claim 1 wherein discovering one or more storage elements comprises retrieving storage element capabilities from a knowledge base.

7. A method as recited in claim 1 wherein mapping each of the discovered storage elements to associated capabilities comprises characterizing each of the storage elements by one or more of types of services, capacity, and bandwidth that the storage element is capable of delivering.

8. A method as recited in claim 7 further comprising mathematically optimizing a function representing attainment of service level objectives at minimum cost based on heuristics of the managed storage elements.

9. A method as recited in claim 1 further comprising generating the storage solutions.

10. A method as recited in claim 9 wherein generating the storage solutions comprises determining one or more of a path assignment hierarchy, a volume assignment hierarchy, a backup recovery assignment hierarchy, and a replication assignment hierarchy.

11. A method as recited in claim 10 wherein the generated assignment hierarchies result in workflow definition language for driving implementation of the hierarchical processes.

12. A method as recited in claim 1 wherein mapping each of the capabilities to associated storage solutions comprises generating a logical unit number (LUN) assignment solution set.

13. A method as recited in claim 1 wherein generating a LUN assignment solution set comprises determining one or more of a path assignment solution set, a volume assignment solution set, a backup recovery assignment solution set, and a replication assignment solution set.

14. A method for modeling provisioning of planned storage elements, the method comprising:
based on data characterizing planned storage elements, analyzing a level of service level attainment based on addition or deletion of planned storage elements; and
determining changes in provisioning policies and rules based on the planned storage element addition or deletion.

15. A system for determining storage provisioning policy rules for use in a network having storage elements, the system comprising:
a discovery engine operable to identify storage elements available for provisioning; and
an adaptive engine operable to map solutions to service level objectives and map storage element capabilities to solutions to generate the storage provisioning policy rules.

16. A system as recited in claim 15 further comprising a graphical user interface enabling a user to set the service level objectives.

17. A system as recited in claim 16 wherein one service level objective is dependent upon another service level objective, and the graphical user interface automatically adjusts the one service level objective when the another service level objective is set.

18. A system as recited in claim 15 further comprising an automated provisioning engine that provisions storage elements according to the storage provisioning policy rules.

19. A system as recited in claim 15 wherein the adaptive engine is further operable to present a user interface enabling a user to enter modeling data for modeling storage elements that could be added.

20. A system as recited in claim 15 wherein the adaptive engine generates an assignment solution set associating solutions with storage element capabilities.

21. A system as recited in claim 16 wherein the assignment solution set includes one or more of a path assignment solution set, a backup recovery assignment solution set, a volume assignment solution set, and a replication assignment solution set.

22. A system as recited in claim 15 wherein the adaptive engine generates assignment hierarchies setting forth a workflow definition language facilitating implementation of hierarchical processes associated with provisioning the storage elements.

23. A system for deriving rules for provisioning storage elements in a network having one or more storage elements, the system comprising:
a discovery engine identifying available storage elements;
means for mapping solutions to capabilities associated with the storage elements to generate an assignment solution set; and
means for mapping solutions in the assignment solution set to service level objectives to be met by the storage area network, thereby generating solutions for use in provisioning storage elements.

24. One or more data structures on a computer-readable medium for use by a computer to derive policy rules for provisioning storage resources in a network, the one or more data structures comprising:
an objective field designating an objective to be met by the storage area network, wherein the objective is selected from a group comprising a recovery point objective, a recovery time objective, a backup window objective, a provisioning time objective, a cost objective, an availability objective, a read input/output performance objective, and a write input/output performance objective; and
a solution field designating a solution that meets the objective.

25. One or more data structures as recited in claim 24 further comprising a storage element capabilities field designating a storage element capability that can implement the solution.

26. One or more data structures as recited in claim 25 further comprising:
a capability component field designating a capability component; and
an effectiveness coefficient field designating an effectiveness coefficient associated with the capability component, the effectiveness coefficient for use in determining effectiveness of a capability.

27. One or more data structures as recited in claim 24, wherein the objective can be modified through user input.

28. A computer-readable medium having computer-executable instructions, which when executed by a computer, cause the computer to perform a process comprising:
discovering storage elements connected to a network; and
adaptively deriving policy rules for provisioning the storage elements, wherein adaptively deriving comprises mapping storage element capabilities to solutions and calculating a performance effectiveness coefficient indicating a level of effectiveness associated with selected storage element capabilities.
